(19) United States
(12) Patent Application Publication
(10) Pub. No.: US 2004/0199631 A1
(43) Pub. Date: Oct. 7, 2004

(54) Ubiquitous information utilities and services for convention center

(75) Inventors: Manabu Natsume, San Mateo, CA (US); Yoichi Shintani, Palo Alto, CA (US); Tomohisa Kohiyama, Sunnyvale, CA (US)

Correspondence Address: David T. Cunningham, Esq., Hitachi America, Ltd., 50 Prospect Avenue, Tarrytown, NY, 10591, US

(73) Assignee: Hitachi, Ltd., Tokyo (JP)

(21) Appl. No.: 10/393,901

(22) Filed: Mar. 21, 2003

(51) Int. Cl. G06F 15/16; G06F 15/173

(52) U.S. Cl. 709/225

(57) ABSTRACT

A multimedia presentation of information at a promotional event provides wireless communication between a user multimedia presentation and capturing device and system units of the event management and exhibitors that are connected by a LAN while the user is attending the event. The system units have functions of: detecting the location and movement of the user on a real time basis; analyzing the current location of the user relative to coordinates of the event location; mapping the user location to a map of the event, which map includes fixed support facilities such as restrooms and food dispensers, exhibit stations and temporary or movable presentations such as lectures or demonstrations; providing a location of stations having relevant information based upon past and current 9behavior of the user and based upon current location and movement of the user; efficiently providing the relevant information at a relevant station wirelessly to the user device based upon device location, a user behavior profile and user choices and requests; quickly and conveniently transport and/or storage of multimedia information collected and captured by the user, for example during visits to different stations; analyzing the behavior of the user and providing a user profile to interested parties such as the user, the event organizers and the exhibitors, and basing the profile on, for example, the time that a user is at a specific location, the information requested and rejected, the information collected and captured and its frequency of collection or capture; and providing both off location (for example over the Internet) or on location access to the storage for the convenient retrieval of the information stored to or referenced in the user account after or during the event.

### FIELD OF THE INVENTION

The present invention relates to improving the efficiency of a user with a portable device in the presenting, finding, experiencing, collecting or receiving, transporting, editing, capturing, storage and retrieval of multimedia information available at a plurality of information stations, for example product, service and exhibit booths at a convention, show or exhibit.

### BACKGROUND OF THE INVENTION

There are many problems associated with the presenting, finding, experiencing, collecting or receiving, transporting, editing, capturing, storage and retrieval of multimedia information provided at public displays and spaces (stations) at an information location.

For example, such stations are included in information locations such as museums, convention centers, retail stores, cruise ships, information kiosks and the like that provide information to users. In the past, various electronic and printed devices have been provided to assist people in navigating such locations, to find particular stations of interest and having information of interest.

The users of such information locations have been able to collect printed information or independently take photographs at the information stations. When information is in the form of printed matter, it quickly becomes burdensome for the user to carry the printed matter from station to station within the location, and the provision of such printed matter is a burden on the information provider with respect to initial cost, duplication, distribution and storage.

Many times there are physical exhibits at an information station, and the user has a difficult time retaining a mental image, particularly after viewing many such sites. Of course, it is common for a user to carry a camera, but again there is the burden of remembering to bring a camera and enough film or other image recording media.

Many times the information provided is in the form of paintings, artifacts, various merchandise, live performances, audio information, computer-generated demonstrations, and other mixed media, which provide their own problems of remembering, presenting, receiving, transporting and storing.

There have been many attempts to provide technology to help both the user and the information provider. For example, museums provide portable audio devices that may be activated at certain locations to provide a particular user with information as to that location or the exhibits at that location.

U.S. Patent Publication US2002/0068991 A1, published Jun. 6, 2002, to Fitzsimmons, relates to a system for display of such information in a public facility. For example, the information provider may be a museum having various exhibits or a convention center or a retail environment to deliver information relating to products or services. The information delivered would include high quality audio, video and static images.

In Fitzsimmons, the user has a portable device that includes a headset for providing the user with audio input, a liquid crystal display, a bookmark key, a help key, numeric keys for the entry of information, and play/pause keys. Individual units provide the functions. The units are connected together or they may be combined into a single portable device. The portable user device includes a processor, random access memory (DRAM), battery, and a radio frequency (RF) audio receiver. The audio receiver receives information from a display facility by wireless communication. Stored files may be compressed or uncompressed. Communication is provided between the user device and a facility's main processor, for upload of current content and/or application software, and to download recorded information about user inputs.

The Fitzsimmons facility includes a plurality of exhibit areas that have a corresponding number of IR, infrared, transmitters. The main facility has a user profile database. Upon entering the facility, a user is provided with a unique identifier, in the form of a ticket, at a reception area. The unique ticket number is uploaded to the portable device and stored.

Proximity detectors of Fitzsimmons provide RF wireless communication with the portable device to inform the portable device that it is at a specific area and/or approaching a specific exhibit. With such identification, the portable device provides the user, from its own storage, with context sensitive menu selections, help functions, introductory audio clips, a list of artifact clips, and other information corresponding to the exhibit. The user is provided with an opportunity to select additional information from the device memory about the artifacts, for example, each artifact can be labeled with a unique identifier and the user can enter the identifier via numeric keys. Alternatively, such a selection can be presented on the touch screen of the user device. When selection is made by the user, corresponding content is received from the internal hard disk of the user device, and the information may be in the form of an audio file, text or images.

Once the Fitzsimmons user has completed the tour, the portable device is docked at a main facility for recharging of the battery and data/content transfer. The stored strokes and the unique user ID are downloaded to the user profile database made available to various applications. Optionally, an RF LAN may be used for data upload and download to and from the portable device at the reception area after the user is turned in and the user leaves the premises, without requiring docking.

In Fitzsimmons, after the user has left the facility, the user may access the facility's content library via the World Wide Web (WWW) and obtain information concerning various artifacts through the facility library.

The Fitzsimmons audio device can be used to enter an ID associated with a video display, and the portable selection device can tune the internal RF audio frequency receiver to an appropriate channel to pick up the associated audio via a nearby gallery transmit antenna. That is, a particular station will transmit audio material to accompany a video that is being displayed.

The Fitzsimmons user can use the bookmark key of the selection device to record the identification of the element of interest for later use outside the facility. The identification of the element by the user indicates that the user wants more information, and this preference is time stamped and provided with the user ID. Then, once the user has left the facility and turned in the portable device, the user may visit the facility library through the WWW to obtain even more detailed information relating to the bookmark elements of interest.

The Fitzsimmons portable device may also collect information such as “how did you like that exhibit?” Once the user has turned in and docked the user device, the keystroke and query information can be processed by the user profile database server to create usage reports for museum exhibitors, to aid in marketing products associated with the museum, etc. The bookmarks are stored in a table at the facility to include the unique user ID and additional data such as time and date stamped information associated with each bookmark action. The facility can use the bookmark information to tailor a portable interface device to a particular known user upon the occurrence of a subsequent visit, based on the user's previous selections. The bookmarks can be linked to additional product or service information on the web. When the user enters the facility, after a previous entry, data may already exist in that particular user's profile database. Then the device operation can be tailored for the user's past preferences.

Various techniques are known for providing a user's portable device with map information, for example as shown in U.S. Patent Application Publication US2002/O103781 A1.

U.S. Pat. No. 6,226,589 B1, issued May 1, 2001 to YOSHIHARU, et al relates to a system for managing and storing positional information and attribute information about a number of unspecified mobile objects, such as people, creatures, objects, etc.; the objects are in general moving outdoors. For example, a portable unit may be located in a taxi or delivery vehicle, and the driver may be assisted in searching for a destination from map information that is provided on a display. Communication would be provided by radio transmission, wherein the mobile unit would measure its own location and transmit positional information to a central location. Such transmission may occur, for example when a position exceeds a predetermined reference value or when exceeding a predetermined time, or upon request. An example of usage is, when a person is within a given area of a shop, the shop may broadcast bargain information.

U.S. Patent Application Publication US2002/0055872 A1, published May 9, 2002, to LABRIE, et al, relates to a navigation system wherein a user (e.g. visitor, guest or passenger) at a site such as a resort, ski resort, amusement park, cruise ship, hotel, hospital, airport, educational campus or corporate campus is provided with a mobile electronic device with wireless network technology for improving the overall experience of the user by reducing the delays, long lines, miscommunications, missed opportunities and redundant business practices that may inconvenience a user at such facilities. As an example, at the end of each cruise, or alternatively for another site at the end of a specific event or time period, all profiles of each user are stored in a database warehouse, and a profile is created. The user is provided with identification, such as a driver's license, in the facility database. Information may be provided to the user, for example the times that an activity is available may be provided to the user after a real time database query.

U.S. Patent Application Publication US2002/0047861 A1, published Apr. 25, 2002, to LABRIE, et al, relates to providing services and information management for a user who is a visitor, guest or passenger at a site such as a resort, ski resort, amusement park, cruise ship, hotel, hospital, airport, educational campus or corporate campus. The facility's server includes information relating to users of the site and a navigation database. Upon receiving a user request for information relating to a site from a terminal device over a communication network specifically serving the site, the database is searched for the requested information and the information is then transmitted to the terminal device used by the user.

United States Patent Application Publication US2002/0090954 A1, published Jul. 11, 2002, to TANAKA, et al, relates to a plurality of mobile users in wireless communication with bay stations. A user may be connected to one or more other users when they have compatible attributes and when they are located within a predetermined distance of each other. Connection may be established between users based upon such attributes or upon request of a specific user.

United States Patent Application Publication US2002/OO95333 A1, published Jul. 18, 2002, to JOKINEN, et al, relates to wireless coupon or promotional coupon handling between various service users over a mobile network to portable devices. In this matter, advertising messages are delivered to mobile terminals, particularly “e-coupons”. The users provided the information are identified by certain criteria, such as fitting a particular e-user profile and/or users at a particular desired location.

United States Patent Application Publication US2002/0111172 A1, published Aug. 15, 2002, to DeWolf, et al, relates to location based profiling. A subscriber's daily activities and the locations traveled while partaking in these activities are observed and a psycho-demographic profile is developed. The pattern of activities is associated with a time and frequency component that is then used to predict a subscriber's activity. The retrieved data includes that characterizing the location visited by the subscriber.

In DeWolf, et al, the subscriber is provided with a user device in the form of a wireless device that may be a personal digital assistant (PDA), such as a PALM Pilot or Handspring device, an Internet enabled vehicle, a portable computer having a wireless Internet connection, a combination wireless phone/PDA or any other device now known or later conceived that provides wireless communications. The location of the subscriber is monitored and can be utilized to assist in the delivery of information and services to the subscriber.

The DeWolf, et al collected profile information includes in addition to the location, the establishments located within the location. The profiler may use a map database to aid in the generation of the location profile. The attributes include time of day, day of week and type of activity, for example shopping or commuting. Communication may be at predetermined intervals, such as every five minutes. The observed activities are categorized by analyzing the time data, frequency, route, etc. associated with the subscriber. Locations may be determined by a global positioning system (GPS). The profile can also be generated based upon the frequency (seldom, frequently) of phone calls and the establishments called. The subscriber could be prompted to enter a personal identification number (PIN) or place a finger (for example, a thumb) over a scanner, all towards providing authentication. The purchase of specific products and services could be incorporated in the subscriber profile. The profile created could include weighting factors. The data may be aggregated for a specific time period, for example one week or one month. The profiling would include probabilistic measurement of the likelihood of the subscriber partaking in particular activities.

Therefore, there is a need for an improvement in the finding, experiencing, collection, editing, storage and retrieval of multimedia information available at a plurality of information stations at an information location.

### SUMMARY OF THE INVENTION

These and other needs are addressed by the present invention.

The present inventors have analyzed the above-mentioned problems, identified and analyzed causes of the problems, and provided solutions to the problems. The analysis of the problems, the identification and analysis of the causes, and the provision of solutions are each parts of the present invention and will be set forth below.

As a result of analyzing the prior art relating to multimedia presentation of information at a promotional event, the inventor has found an event guest's need for an improvement in the location of stations having relevant information, in the efficient obtaining of the information at a relevant station, in the quick and convenient transport and/or storage of the information between visits to different stations, and in the convenient retrieval of the information after the event.

Therefore, the present invention analysis of the prior art system as to its problems and their causes has lead to the need for and the solution of a more effective system to assist a user or guest at an information presentation location.

The multimedia presentation of information at an information location is provided by wireless communication between a user device that has multimedia presentation and capturing, information location management system units of the location management system, and exhibitors. The exhibitors and management units are connected by a LAN while the user is attending the event. The system units have functions of: detecting the location and movement of the user on a real time basis; analyzing the current location of the user relative to coordinates of the event location; mapping the user location to a map of the event, which map includes fixed support facilities such as restrooms and food dispensers, exhibit stations and temporary or movable presentations such as lectures or demonstrations; providing a location of stations having relevant information based upon past and current behavior of the user and based upon current location and movement of the user; efficiently providing the relevant information at a relevant station wirelessly to the user device based upon device location, a user behavior profile and user choices and requests; quickly and conveniently transporting and/or storing of multimedia information collected and captured by the user, for example during visits to different stations; analyzing the behavior of the user and providing a user profile to interested parties such as the user, the event organizers and the exhibitors, and basing the profile on, for example, the time that a user is at a specific location, the information requested and rejected, the information collected and captured and its frequency of collection or capture; and providing both off location (for example over the Internet) or on location access to the storage for the convenient retrieval of the information stored to or referenced in the user account after or during the event.

The above solution of the present invention provides flexibility and efficiency in the obtaining of multimedia information.

Still other aspects, features, and advantages of the present invention are readily apparent from the following detailed description, simply by illustrating a number of particular embodiments and implementations, including the best mode contemplated by the inventor for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

The present invention is usable in the environments and with the additional elements suggested by the Fitzsimmons publication, whose disclosure is incorporated herein in its entirely.

### BRIEF DESCRIPTION OF THE DRAWINGS

The present invention is illustrated by way of a preferred embodiment, best mode and example, but not defined by way of limitation. Further objects, features and advantages of the present invention will become more clear from the following detailed description of a preferred embodiment and best mode of implementing the invention, as shown in the figures of the accompanying drawing, in which like reference numerals refer to similar elements, and wherein:

FIG. 1 discloses an exemplary mobile or portable user device, which is provided to or owned by and carried by a user of the information system of the present invention;

FIG. 2 shows the system architecture for an information location employing the management system of the present invention, with a Convention Center being used as an example information location;

FIG. 3 is a representative scenario for a user's activities at the Convention Center for location based information distribution;

FIG. 4 illustrates a representative scenario of the part of location based information distribution at the Convention Center, wherein a user wants information;

FIG. 5 illustrates a representative scenario of the part of location based information distribution at the Convention Center, wherein the user already has information;

FIG. 6 illustrates a representative scenario of the part of information forwarding, more particularly the user at the Convention Center storing multimedia information for future off-site or on-site browsing and/or downloading;

FIG. 7 illustrates a representative scenario of an exchange of multimedia information between first and second users, for example two visitors to the Convention Center.

FIG. 8 illustrates a representative scenario of access to each user's information storage at the Convention Center;

FIG. 9 illustrates a representative scenario for the gathering of time information relating to the behavior and actions of the user at the Convention Center to be used in real-time profiling and the provision of suggestions; and

FIG. 10 illustrates a representative scenario for the gathering of category information relating to the behavior and actions of the user at the Convention Center.

### DESCRIPTION OF THE PREFERRED EMBODIMENT

Still other aspects, features, and advantages of the present invention are readily apparent from the following detailed description, simply by illustrating a particular embodiment and implementation, including the best mode contemplated for carrying out the present invention. The present invention is also capable of other and different embodiments, and its several details can be modified in various respects, all without departing from the spirit and scope of the present invention. Accordingly, the drawing and description are to be regarded as illustrative in nature, and not as restrictive.

An apparatus, system, method and stored software for presentation and collection of multimedia information at a presentation event are described. In the following description, for the purposes of explanation, numerous specific details are set forth in order to provide a thorough understanding of the present invention. It is apparent, however, to one skilled in the art that the present invention may be practiced without these specific details or with an equivalent arrangement, even though in some cases the details are important for the narrower interpretations of the invention. In other instances, well-known structures and devices are shown in block diagram form in order to avoid unnecessarily obscuring the present invention.

The preferred embodiment satisfies the above-mentioned needs by identifying their root problems and the causes of the problems, and after analysis, solving the mentioned problems.

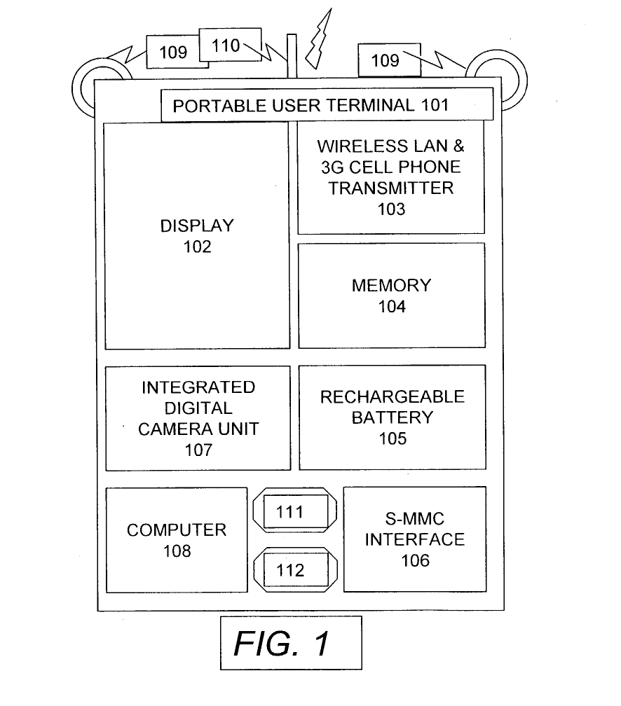

FIG. 1 discloses a mobile, i.e. portable, user device 101. The user device may be a personal data assistant (PDA), such as a PALM Pilot or Handspring device, an Internet enabled vehicle, a portable computer having a wireless Internet connection, a combination wireless phone/PDA or any other device now known or later conceived that provides wireless communications. The portable user device 101 may be provided by the event management for use only at the event, be on sale, be owned by the user, or a combination of the above.

The user device 101 includes a conventional display 102, which may be a Liquid Crystal Diode (LCD) screen, preferably with pen touch recognition and color graphics or any other device now known or later conceived that provides still or moving video information and which can receive user input. Further examples of a display involve a cathode ray tube (CRT), active matrix display, or plasma display, for providing information to the user. The display may be used either standing or lying. Further examples of a user input device include a keyboard or touch-pad including alphanumeric and other keys for communicating information and command selections to the processor 108. Another type of user input is cursor control, such as a mouse, a trackball, a joystick, eye movement sensor, voice recognition, or cursor direction keys for communicating direction information and command selections to the processor 108 and for controlling cursor movement on the display.

The user device 101 further includes a wireless-LAN (Local Area Network) and 3G (Third Generation Mobile System). transmitter and receiver 103 that is integrally housed with the display 102. The wireless transmission line, from the user device 101 to one or more transmitting and receiving units of the information management system or a distributed station of the overall system or unique station, may involve conventional or future developed cell phone or other wireless technology.

The wireless transmission line can take the form of acoustic, optical, or electromagnetic waves, such as those generated during acoustic wave, radio frequency (RF) and infrared (IR) data wireless communications. While the present invention is usable with both known technology and that to be developed in the future with respect to wireless transmission, the preferred embodiment and best mode employs a 3G system (Third Generation Mobile System). At present, the 3G system includes greater band width, more sophisticated compression technique and the inclusion of in-building systems, which is particularly useful with the present invention wherein the facilities may be within a single building or underground.

A user device, for example the terminal 101, is used herein to mean an entity carried by the user to assist in identifying and locating stations of interest, identifying and locating the user relative to the facility, providing communication with a centrally or remotely located information center or distributed information centers for downloading and uploading of various mixed media, and for handling storage analysis and transmittal to and from storage of mixed media and other data.

The wireless LAN link 103 typically provides data communication through one or more networks (LAN and/or WAN) to other data devices. For example, wireless LAN link 103 may provide a connection through a local network (LAN) within the information location, e.g. the Convention Center, to a central host computer, which has connectivity to the local Convention Center area network (LAN) and further to a wide area network (WAN), for a global packet data communication network now commonly referred to as the “Internet”) or to data equipment operated by service provider. The signals through the various networks and the signals on network link 103 and through communication interface 106, which communicate digital data with other computer systems, are exemplary forms of carrier waves bearing the signals of information and instructions to perform the functions of the present invention.

The transmitter/receiver preferably communicates through some type of conventional antenna 110.

The user device 101 further includes a memory 104 that stores the operating system for the processor 108, the operating system and programs for the integrated digital camera 107, the controller for the transmitter/receiver 103, application code for controlling the method of the present invention from the user device side, temporary data, temporary variables or other intermediate information during execution of instructions to be executed by the processor 108, and permanent storage of data for later retrieval.

The memory 104 may be several separate storages for different functions and include one or more of storage media, such as: a random access memory (RAM) or other dynamic storage device, a transmission line, a read only memory (ROM), an optical disc, a magnetic disk, a hard-drive, a flash memory, a floppy disk, a flexible disk, a hard disk, a magnetic tape, any other magnetic medium, a CD-ROM, CDRW, DVD, any other optical medium, punch cards, paper tape, optical mark masks, any other physical medium with patterns of holes or other optically recognizable indicia, a PROM, an EPROM, a FLASH-EPROM, any other memory chip or cartridge, a carrier wave, or any other medium from which a computer can read code.

Computer readable media to carry code according to the embodiments refers to any medium that participates in providing code according to the invention to a processor for execution. The computer readable media stores or provides static or volatile information and instructions, or other data and code, for the processor 108. For example, the instructions for carrying out at least part of the present invention may initially be on a magnetic disk computer-readable media of a remote computer and be transmitted to the memory 104 over a wireless transmission line. In any event, the invention includes code modification instructions on a computer readable medium and as a data stream signal.

the preferred embodiment employs RF wireless transmission to and from the user device 101, but other technologies may be used. For example, the instructions for carrying out at least part of the present invention may initially be borne on a magnetic disk of a remote computer at a central location or at an information station. An information station may convert the data to an infrared signal and transmit the infrared signal to the portable user device 101. An infrared detector as a part of the transmitter/receiver 103 on the portable user device 101 receives the information and instructions borne by the infrared signal and places the data on the bus. The bus conveys the data to main memory of memory 104, from which the processor 108 retrieves and executes the instructions. The instructions may optionally be stored either before or after execution by processor or not at all.

The user device 101 further includes a rechargeable battery 105 that may be of any conventional type or to be developed battery in recognition that technology is changing constantly. Non-rechargeable batteries may also be employed, but rechargeable batteries are preferred. The details of the battery form no part of the present invention, except that they provide necessary power for operating and controlling the memory, providing power for wireless transmission, provide the power for the display, provide the power for operating the integrated digital camera unit, powering the processor 108, and the like conventional powering functions. Alternatively the digital camera unit has a power supply separate from the battery 105. More generally, the battery 105 is a power supply and as such includes other technologies, for example where power is wirelessly supplied to the user device 101, for example with microwave energy.

The user device 101 further includes an interface or system for multimedia communication (S-MMC) interface 106. The multimedia interface provides for the exchange of multimedia data between the processor 108 and the display 102, digital camera 107, transmitter/receiver 103, memory 104 and the like while additionally providing such functions as compression, decompression, format changes and the like for the multimedia data. The S-MMC interface may be of any known type or that developed in the future for providing such functions. Further, the communication interface 106 can include peripheral interface devices, such as a Universal Serial Bus (USB) interface, a PCMCIA (Personal Computer Memory Card International Association) interface, etc.

The user device 101 further includes an integrated digital camera unit 107, which may be built into the user device 101, or a separate conventional digital camera may be connected to the user device 101 by a suitable cable to constitute the unit. In the latter case, the digital camera can be hand held and used in the conventional manner or stored around the neck on a lanyard, while being connected operatively to the remainder of the portable user device 101 by a cable, with the remainder of the portable user device being secured to a backpack, or a belt. The digital camera unit 107 may have its own power supply or draw power from the rechargeable battery 105.

The user device 101 further includes a computer or processor 108. The processor 108 provides the conventional functions of executing the instructions of the application codes stored in the memory 104 or provided wirelessly and according to the operating system stored in the memory 104, for control over and interaction with a conventional bus, the display 102, transmitter/receiver 103, the memory, S-MMC interface 106, the digital camera unit 107 and the like. While the digital camera unit 107 may have its own processor, it is also envisioned that the digital camera unit 107 may be a dumb unit and use the computer processor 108 for controlling the capture, the processing, the storing and the transmission of image data. The integrated digital camera unit 107 captures images as still frames singly or at spaced intervals, with the spaced intervals being selectively variable for providing selective spacing for a range of effects from stop action still photography to continuous movie-like action, all of which is herein defined as video. The control of the digital camera is by the user. Alternatively or selectively the digital camera has standard automatic features, such as focusing, zoom and light control.

The user device 101 further includes a plurality of jog dials 109 operatively coupled to provide various user inputs, in addition to the touch recognition display 102 and other inputs mentioned above. The user input may involve audio volume control, up/down cursor movement, side cursor movement and the like. These jog dials 109 are merely exemplary, in that the user input may further involve a complete or limited keyboard, a joy stick or cursor control, voice recognition including a microphone 111 and a speaker 112, all for providing instructions to and from the user. Further input may be by way of toggle switches for power on/off, recording speed and the like functions.

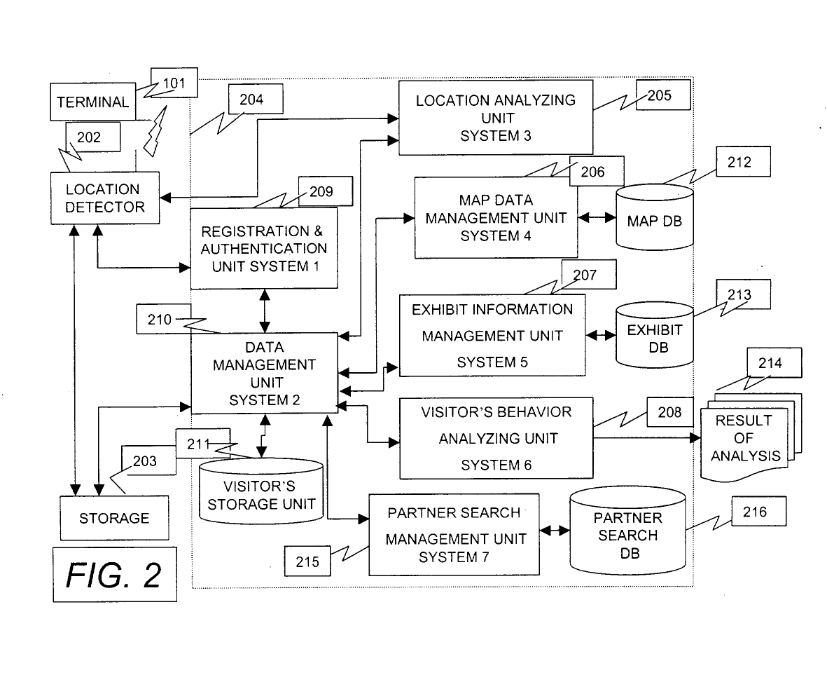

An exemplary information or event system or location used for the purposes of this disclosure is that of a convention center, having a plurality of information provider stations, e.g. exhibitor booths, spread throughout one or more rooms inside of a building. The system architecture for the convention management system is set forth in FIG. 2. The portable user device, e.g., 101, further described in FIG. 1, is in wireless communication with a location detector 202. The location detector may be a plurality of transmitters/receivers locating the portable user device or terminal 101 by means of triangulation or the portable user device 101 may have a global positioning system (GPS) built in to determine location by latitude and longitude. In the latter case, the GPS location is transmitted to the location detector 202.

A mass storage 203 may be onsite at the convention center or off site and connected to the convention management system 204 through a LAN or WAN, e.g. the Internet, specifically the WWW. The storage 203 is operatively coupled to the location detector 202, for example directly by one or more of a cable, wireless communication, a wide area network (WAN) or local area network (LAN), for example. Further, the mass storage 203 is similarly connected or coupled for data transmission and reception to and from the convention management system 204.

The convention management system 204 includes an electronically coupled network, for example a LAN, connecting the location analyzing unit system-3 205, the map data management unit system-4 206, the exhibit information management unit system-5, 207, the user's behavior analyzing unit system-6 208, registration and authentication unit system-1 209, the data management unit system-2 210, the user's storage unit 211, a map database (DB) 212, and an exhibit information database (DB) 213.

The location analyzing unit 205 gathers the location of the information user terminal 101 regularly or periodically via the location detector 202 and sends the detected location of the individual terminals to the data management unit 210.

The exhibit information management unit 207 stores all exhibit information and guides. The information is related with the map data, that is, the exhibit information is overlaid with the map of the convention center so that it may be effectively indexed on location of the corresponding exhibit or even the sub-area within a large exhibit station. This function provides the terminal with the exact information for each station location.

The user behavior analyzing unit 208 analyzes the each user's individual preferences as to interest, by the information requested, the information stored, the time spent at a particular exhibit and the time spent at a particular area within an exhibit station. Trends for not only the individual uses, but also for a class of users or all of the users may be obtained. The results of analysis 214 are provided to individuals and organizations that want to use them. Input of multimedia information at a specific location is representatively sent (for example the information ID of a brochure is sent and not the entire brochure that was downloaded to an interested user) to the user behavior analyzing unit 208 for analysis and may include the number of pictures taken, the running time of audio collected for example from interviews, the time at a location, the types and quantity of information downloaded

Results produced by the user's behavior analyzing unit system-6 208 are transmitted to the exhibitors and/or the users as multimedia output results of analysis 214, which may include hard copies of text, drawings and photographs, or multimedia data transmitted over the Internet by the convention management system 204 automatically or upon request. The profiling includes probabilistic measurement of the likelihood of the subscriber partaking in particular activities. The profile created includes weighting factors.

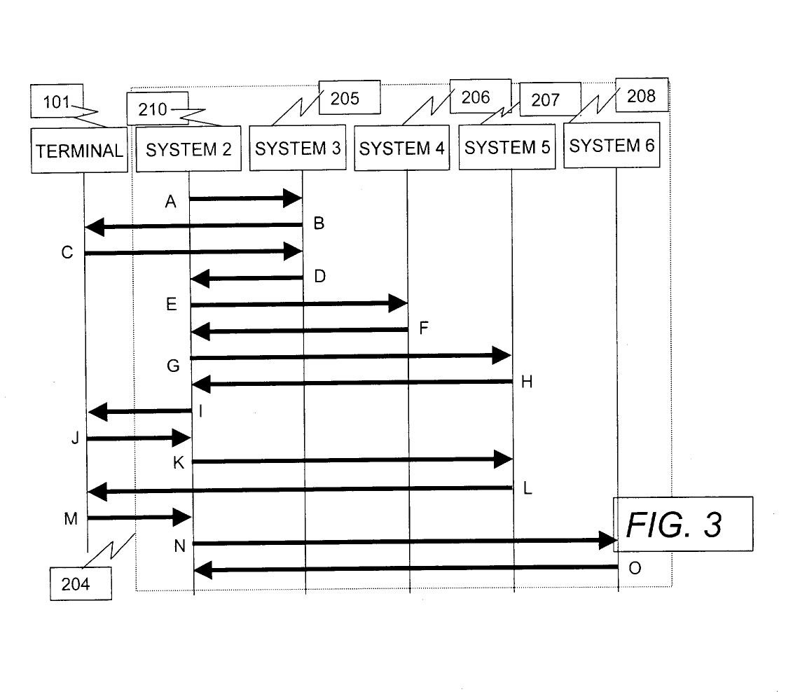

When a user enters the convention center, they are first directed to the registration and authentication unit system-1 209, for example a reception booth, where they present identification, payment and any questions they may have. The identification is used for registration purposes and authentication with respect to a prior user or someone who has advanced registration. At such time, the user is provided with the portable user device 101, for example the terminal, which has a fully charged battery for the source of power and the required software and hardware for supporting the functions and acts described with respect to FIG. 1 and elsewhere. The user may be identified or authenticated by providing a personal identification number (PIN) or providing a finger (for example, a thumb) over a scanner. The registration information may be provided by the user prior to the user's visit to the convention center, for example over the WWW (World Wide Web). Whenever the user activates or starts a new procedure according to FIGS. 3 to 10, although not specifically shown in all of these figures, the user activates the function 209 for authentication by the user entry of the user ID, for example entry of a PIN of S-MMC, etc.

The registration information from the registration and authentication unit system-1 209, is provided over a transmission line to the data management unit 210, which is hardware of known construction for receiving and outputting data, and handling the storage of such data, preferably storing data in compressed form. The data management unit 210 keeps a user's personal information and an address of the data that is gathered by a user. The data management unit 210 periodically calculates and stores the time when a visitor stays in a certain area, for example an exhibit station or restroom, by the location information that is provided by the location analyzing unit. The data management unit 210 also provides such information to the exhibit information management unit 207 and confirms a user's exact location on the real-time map managed by the map data management unit 206.

The data management unit 210 is coupled by a transmission line to and controls the user storage unit 211. Initially, the registration information is stored under an account index that is unique to the user and indexed according to a unique user ID obtained at the time of registration at the registration and authentication unit 209, or according to an advanced registration for an existing account and later authenticated at the registration and authentication unit 209. The user's storage unit is preferably located at a central location in the convention center, but it may also be at a remote location and accessed through a WAN. The user storage unit 211 stores the information and data that the visitor has gathered, or a reference thereto. The information and data that is in the exhibit information management unit 207, more particularly the Exhibit information database DB 213 can be forwarded directly to each user's storage account in the storage 211. Once the visitor stores this data, the user does not need to access the exhibit information management unit.

Information, including the unique ID (identification) and terminal location or signals indicating the same, is transmitted wirelessly between the location detector 202 and the portable user terminal 101. The location detector 202 sends the location of each portable user terminal 101 to the location analyzing unit 205. This identification and location determining preferably are executed automatically at periodic intervals, or upon inquiry from the location analyzing unit 205, or both. The location of each terminal 101 is indexed with respect to the user ID. The location may be in longitude/latitude format, for example with an accuracy of plus or minus three feet or it may be two dimensional grid coordinates for a grid encompassing only the convention center. The conversion from GPS format, for example, to grid format may be handled by the location detector 202 or the location analyzing unit 205.

The location analyzing unit 205 outputs analyzed data to the data management unit 210, for storage of the location of each portable user terminal in the user's storage unit 211, and further for transmission of such location information to the map data management unit 206, wherein each user terminal is mapped as to location on a real time basis. The location of each terminal 101 is managed by superimposing the user ID or a generic terminal icon on a location map, which may be a virtual map existing only in computer storage or a display map for exhibit managers to view. The map data management unit 206 effectively overlays the location of each portable user device 101 on a map of the convention center, which map has graphic objects of a fixed nature having fixed facilities, such as rest rooms, doors, partitions, exhibitor booths, entrance, telephones, refreshment centers, and the like.

The map data is stored in and fetched from the map database (DB) 212, in a form such that the location of any specific user portable device 101 may be fetched according to the user's ID as an index to the user's record. The map data management unit 206, upon request from the user, provides the user with a map of the convention center having the fixed objects thereon, which map is then provided to cover the display 102 or merely to occupy a window thereof, at the user's choice 101. The thus displayed map is further overlaid with the user's current location. In response to a user's request for a specific booth or other facility location, the map data management unit may further overlay graphic instructions such as arrows to the requested location and/or provide audio directions to be broadcast through the portable user device speaker 111 or conventional headphones attached to the portable user device 101.

The map data is on a real time basis, preferably at close intervals of periodic sampling and constitutes a user record. Therefore, the map data provides time and location stamping for various activities of the user that are used in user profiling at the user behavior analyzing unit 208. For example, the location and date stamping is provided by the data management unit 210 to the user behavior analyzing unit 208, which will be explained hereafter or to the exhibit information management unit 207.

The exhibit information management unit 207 stores and fetches exhibit information from its exhibit information database 213. This information includes, by way of example: the fixed location of various exhibitor's booths; the fixed location of food services and restrooms; multimedia information about the exhibitors products and services; scheduling and content information about lectures that are to be given at a lecture area on topics that may be changed throughout the day; and exhibit information including a schedule of events involving such lectures, other presentations and/or entertainment. That is, the exhibit information may be of any type that would be useful to the exhibitors and the users, and to satisfy various inquiries made on their behalf. For example, the user may make inquiry as to the location of an exhibitor handling a type of product, or the location of a specific product, or the location of a service, or a request concerning the location of a public facility such as a restroom.

The exhibit information is transmitted to the portable user device 101 upon inquiry or automatically whenever the user terminal 101 is in the vicinity of a specific exhibit station. In addition to such general information, the exhibit information wirelessly transmitted to the user terminal 101 may be various lists or pull down menus relating to general services or information about an exhibitor at a specific location of the portable user device, to prompt the user for a choice as to information desired. Thus the exhibit information is updated on a real time basis so that updated information is provided to the user throughout their visit at any time and location, without the user being required to return to the reception area for a reloading of information.

The user's behavior analyzing unit 208, in response to visitor or user information such as real time location, preference choices and inquiries or the like, analyzes such user information and creates a user profile. The user profile, under control of the data management unit 210, is stored in the user storage unit 211 or transmitted to a user or exhibitor, preferably by a LAN or WAN as a result of analysis 214. The profile created could include weighting factors and use fuzzy logic.

As an example of user profiling performed by the user's behavior analyzing unit 208, the disclosure of U.S. Patent Application Publication US2002/0111172A1, published Aug. 15, 2002, to DeWolf, et al is incorporated herein in its entirety for purposes of disclosure. In addition, the visitors profiling may include the users preference for information or services as determined by the length of time that a user is in the direct vicinity of a particular exhibitor, as determined by an integration of the time and location (a constant) stamping provided by the location analyzing unit 205.

In the past, a user's preference or interest has been determined merely by a user being at a specific location and/or the user requesting information as to products or services provided at a specific location. However, the present inventors have found that this is unsatisfactory in that it is not truly accurate. For example, the user may pass by a particular exhibit location on the way to another location such as a restroom, or the user may briefly stop at the exhibit area and inquire as to the location of the restroom, but in either case this shows no real interest in the exhibitor. Further, the mere fact that an exhibitor requests exhibit information is not truly indicative of interest, because when receiving the information, the user may quickly determine that they have in fact no interest in the products and services at the location.

Therefore, a better indication of user preference is the length of time that a user stays at a particular location, which is provided by the abovementioned integration of the periodic time stamping. Further, the profiling may be accomplished according to the quantity of information requested or downloaded by wireless communication with respect to the exhibitors station, or the frequency of such requests, and the requested integrated time, information downloaded or inquiries made may be separately weighted as to importance in determining the profiling, for example a request for the location of a restroom would have a zero weighting or multiplying factor for the information station in the vicinity of the user at the time of inquiry, while a request for a product electronic brochure may have a weighting factor of three.

A representative scenario for a user's activities at the Convention Center is set forth in FIG. 3, for location based information distribution.

FIG. 3, ACT 3A: After a user has registered, the data management unit 210 periodically makes a request for location information as to the user by sending the request to the location analyzing unit 205.

FIG. 3, ACT 3B: In response to the request for location information, the location analyzing unit 205 requests, through the location detector 202, terminal/user's ID and location determining information from the portable user device 101.

FIG. 3, ACT 3C: In response to the request, the user's ID and location information (triangulation signals or GPS coordinates, e.g.) are provided wirelessly through the location detector 202 to the location analyzing unit 205.

FIG. 3, ACT 3D: In turn, the location analyzing unit 205 provides location information (the same as or derived from the location information of ACT C) for the specific user ID to the data management unit 210, in response to receiving the location information.

FIG. 3, ACT 3E: Thereafter, the data management unit 210 provides the location information to the map data management unit 206 and requests verification.

FIG. 3, ACT 3F: The map data management unit 206 stores such information in the map database 212 to update the real-time mapping of the user's location. The map data management unit 206 then sends a verification of receipt and storage, as well as the current location of the user relative to the nearest information station, to the data management unit 210.

FIG. 3, ACT 3G: Upon determining that the location of the specific user is within a maximum range of a specific exhibit or other information station 215, the data management unit 210 sends a request to the exhibit information management unit 207, system-5, for exhibit information unique to the station 215 at the user location. Thereby the user device 101 does not need to store a large and adequate amount of information as to all of the exhibitors or to store a manageable small and inadequate amount of information as to all of the users as in the prior art such as Fitzsimmons. The exhibit information is stored at the exhibit information management unit 207 (more specifically in the exhibit information DB 213) and only provided to the user device 101 as needed when the user is in the vicinity of a particular information station 215 and on demand from the user.

FIG. 3, ACT 3H: Upon verification of the authenticity of the request and specifically identified user, the exhibit information management unit 207 sends the results of the inquiry to the requesting data management unit 210.

FIG. 3, ACT 31: The data management unit 210, upon receiving the information, saves the link to the exhibit information management unit 207 and makes inquiry of the user as to what the user would like to obtain, e.g. see or hear, as a download of currently available multimedia information available as to the exhibit station at the user's location. The inquiry is by wireless communication through the users terminal 101 and display of an inquiry message and perhaps display of selection choices, for example choices as to what the user may want to see or hear with respect to the information that is available concerning the specific exhibit station 215, where the user is now located.

FIG. 3, ACT 3J: The user, for example by touch pad, jog dial 109, key stroke, voice command or other input provides a response to the inquiry, i.e. a selection, and indicates specific information that they wish to download. The user response, for example a “yes” as to a specific choice, is transmitted from the user terminal 101 to the data management unit 210.

FIG. 3, ACT 3K: In response to receipt of the choice, the data management unit 210 transmits the user choice over the saved link to the exhibit information management unit 207.

FIG. 3, ACT 3L: In response to the user's choice, the exhibit information management unit 207 transmits the requested information, in multimedia format either compressed or uncompressed, directly to the portable user terminal 101 by wireless transmission. Because the exhibit information management unit has pre-stored the information, there is no need to contact the exhibitor, thus freeing up the exhibitor's resources, both machine and human resources.

FIG. 3, ACT 3M: An acknowledgement is then sent by the portable user terminal 101 to the data management unit 210 indicating the success of receiving the requested information.

FIG. 3, ACT 3N: At that time, the data management unit 210 sends an identification of the user's activity (for example identification of the requested information, the user's ID, a time stamp and location stamp, e.g. exhibit grid coordinates or exhibitor's station stamp) to the user behavior analyzing unit 208, which information is then used to profile the user.

FIG. 3, ACT 30: Periodically or upon request by a user or exhibitor or the data management unit 210 itself, a profile of the user's activity is sent from the user's behavior management unit system 208 to the data management unit 210, to be distributed according to the request. The data management unit 210 uses the profile to find other related activities of interest to the user. The data management unit 210 suggests such other related activities to the user. For example, if the user has just visited a station displaying and/or requested information concerning a specific product type, the data management unit 210 may make suggestions to the user as to other stations relating to that product type.

The user behavior analyzing unit 208 therefore records and analyzes the preferences of the user from the point of view of what material the user does gather.

The data management unit 210 is connected by a WAN, for example, to the Internet and more specifically the WWW (World Wide Web) to function as a library or storage area for downloading information and user profiling to authorized exhibitors and users through direct requests, or a web site.

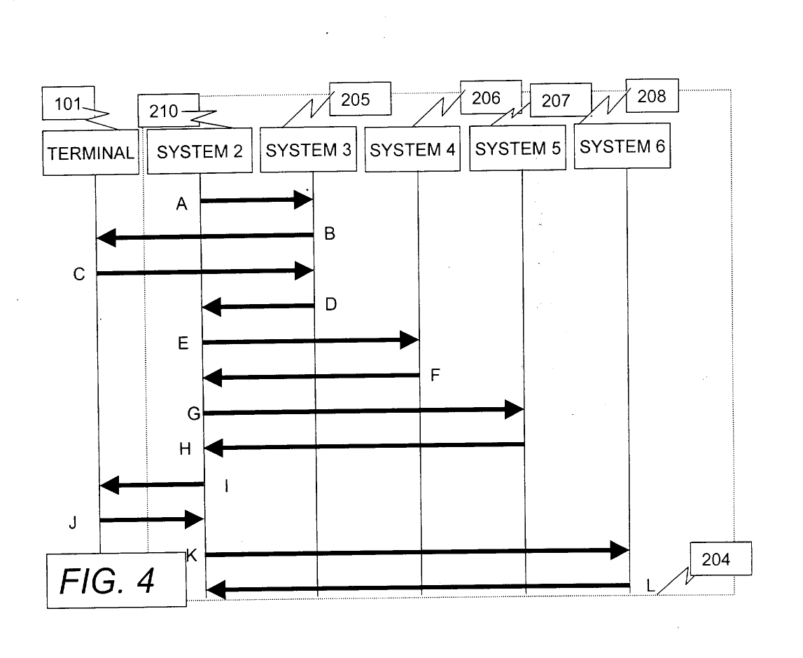

FIG. 4 is a representative scenario for a user's activities at the Convention Center similar to the scenario set forth in FIG. 3, for location based information distribution. In FIG. 3, the user returned a yes answer in ACT J, however, in the scenario of FIG. 4, the user returns a no answer instead of a yes answer in response to the ACT J inquiry from the data management unit.

FIG. 4, ACT 4A: After a user has registered, the data management unit 210 periodically makes a request for location information as to the user by sending the request to the location analyzing unit 205.

FIG. 4, ACT 4B: In response to the request, the location analyzing unit 205 requests, through to location detector 202, location ID and location determining information from the portable user device 101.

FIG. 4, ACT 4C: The user's ID and location information (triangulation signals or GPS coordinates, e.g.) are provided wirelessly through the location detector 202 to the location analyzing unit 205.

FIG. 4, ACT 4D: In turn, the location analyzing unit 205 provides location information (the same as or derived from the location information of ACT C) for the specific user ID to the data management unit 210 in response to receiving the location information.

FIG. 4, ACT 4E: The data management unit 210 provides the location information to the map data management unit 206 and requests verification.

FIG. 4, ACT 4F: The map data management unit 206 stores such information in the map database 212 to update the real-time mapping of the user's location. The map data management unit 206 then sends a verification of receipt and storage, as well as the current location of the user relative to the nearest information station, to the data management unit 210.

FIG. 4, ACT 4G: Upon determining that the location of the specific user is within a maximum range of a specific exhibition or information station 215, the data management unit 210 sends a request to the exhibit information management unit 207, system-5, for exhibit information unique to the station 215 at the user location. Thereby the user device 101 does not need to store a large and adequate amount of information as to all of the exhibitors or to store a manageable small and inadequate amount of information as to all of the users as in the prior art such as Fitzsimmons. The exhibit information is stored at the exhibit information management unit 207 (more specifically in the exhibit information DB 213) and only provided to the user device 101 as needed when the user is in the vicinity of a particular information station 215 and on demand from the user.

FIG. 4, ACT 4H: Upon verification of the authenticity of the request and specifically identified user, the exhibit information management unit 207 sends the results of the inquiry to the requesting data management unit 210.

FIG. 4, ACT 41: The data management unit 210, upon receiving the information, saves the link to the exhibit information management unit 207 and makes inquiry of the user as to what the user would like to obtain, e.g. see or hear, as a download of currently available multimedia information available as to the exhibit station at the user's location. The inquiry is by wireless communication through the users terminal 101 and display of an inquiry message and perhaps display of selection choices, for example choices as to what the user may want to see or hear with respect to the information that is available concerning the specific exhibit station 215 where the user is now located.

FIG. 4, ACT 4J: The user, for example by touch pad, jog dial 109, key stroke, voice command or other input provides a negative response to the inquiry. The user response, for example, indicates that there is no specific information that they wish to download or a “no” as to a specific choice, is transmitted from the user terminal 101 to the data management unit 210.

FIG. 4, ACT 4K: Upon receipt of the negative response from the user, the data management unit 210 deletes or releases the saved link. Then the data management unit 210 communicates with the user behavior analyzing unit 208 to provide information that the specific user is not interested in the specific information that was sent to the user for approval. The user behavior analyzing unit 208 therefore records and analyzes not only the preferences of the user from the point of view of what material the user does gather, but also analyzes the preferences of the user from the point of view of what material the user is aware of but does not want.

FIG. 4, ACT 4L: Periodically or upon request by a user or exhibitor or the data management unit 210 itself, a profile of the user's activity is sent from the user's behavior management unit system 208 to the data management unit 210, to be distributed according to the request. The data management unit 210 uses the profile to find other related activities of interest to the user. The data management unit 210 suggests such other related activities to the user. For example, if the user has just visited a station displaying and/or requested information concerning a specific product type, the data management unit 210 may make suggestions to the user as to other stations relating to that product type.

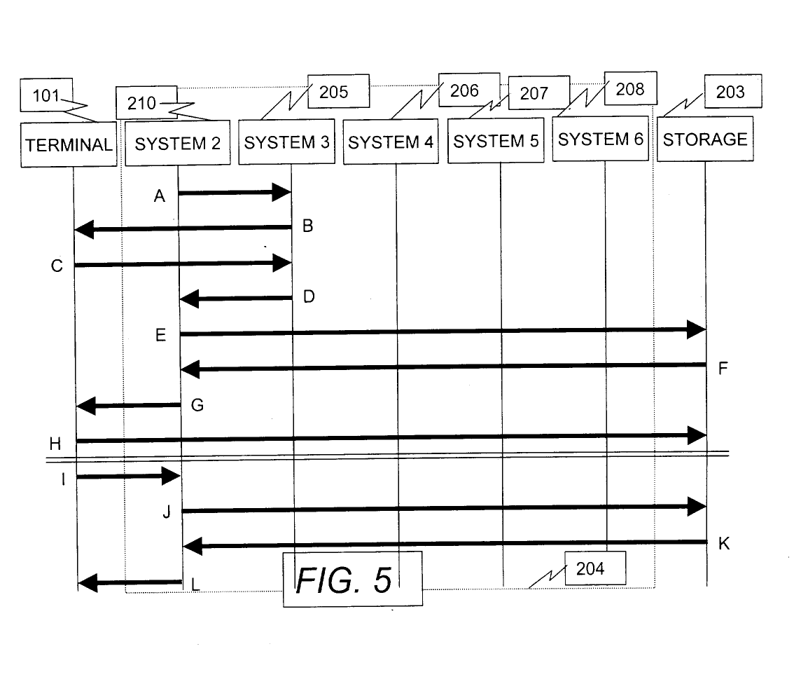

FIG. 5 illustrates a scenario for location based information distribution, wherein the user already has information.

FIG. 5, ACT 5A: After a user has registered, the data management unit 210 periodically makes a request for location information as to the user by sending the request to the location analyzing unit 205.

FIG. 5, ACT 5B: In response to the request, the location analyzing unit 205 requests, through the location detector 202, location ID and location determining information from the portable user device 101.

FIG. 5, ACT 5C: The user's ID and location information (triangulation signals or GPS coordinates, e.g.) are provided wirelessly through the location detector 202 to the location analyzing unit 205.

FIG. 5, ACT 5D: In turn, the location analyzing unit 205 provides location information (the same as or derived from the location information of ACT C) for the specific user ID to the data management unit 210 in response to receiving the location information.

FIG. 5, ACT 5E: Upon receipt of the location of the user terminal 101 relative to the Convention Center, for example a Convention Center grid coordinate or merely that the specific user terminal 101, with unique ID, is still at the same information station as last reported and therefore the user already has the downloaded information concerning that station from the procedures of FIG. 3. The management unit 210 thereby makes a confirmation of log and sends a request to connect the identified user terminal 101 to the storage 203.

FIG. 5, ACT 5F: The storage 203 sends an allowance to connect the identified user terminal 101 to the management unit 210.

FIG. 5, ACT 5G: Upon receipt of the allowance to connect, the management unit 210 informs the identified terminal 101 of the allowance to connect to the storage 203.

FIG. 5, ACT 5H: The user who already has the downloaded multimedia information concerning the specific station just visited or still being visited, sends one or more references identifying one or more portions of that multimedia information that the user is interested in storing for future use. The information itself may be sent, but more preferably only an identification of the portions of interest is sent. The communication is wireless and directly from the user terminal 101 to the storage 203. The wireless communication may be directly to the storage 203 or to a node of a LAN or WAN that passes on the communication to the storage at a remote location. In addition the communication may include video that the user has captured on site. In addition the communication may include audio that the user has captured on site, for example as interviews with people attending to the station of interest or fellow users that the user has met at the Convention Center.

FIG. 5, ACT 51: After the user has returned the user device 101 to the reception area of the Convention Center and after the user has left the Convention Center, the user can send an off-line (with respect to the LAN of the Convention Center having nodes for the elements 202, 205, 206, 207, 208, 209, 210, 211, 212 and 213) request to the data management unit 210, or a separate data management unit. The request is preferably sent via the Internet although other forms of communication may be used. The request involves a desire to access the information stored in act 5H or repeated acts 5H.

FIG. 5, ACT 5J: The data management unit 210, sends the off-line request to the storage 203.

FIG. 5, ACT 5K: The storage 203 confirms or authorizes the off-line request to establish communication with the user.

FIG. 5, ACT 5L: The management unit, for example data management unit 210, sends the off-line confirmation to the user. Thereafter, dependent upon the off-line confirmation, the user engages in a session to browse and download selected portions or all of the multimedia information saved or referenced, for example, by the acts 5H of FIG. 3.

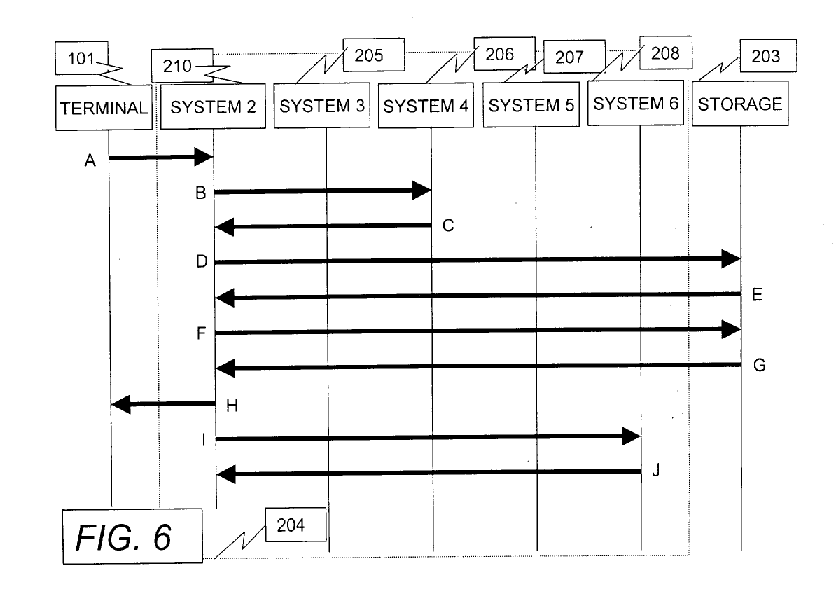

FIG. 6 discloses user storing of multimedia information for future off-site browsing and downloading. In FIG. 5, the user stored information (for example captured video or audio) that was on the memory 104 of the user device 101, with the storage being to the mass storage 203 for later retrieval, for example off-line retrieval. In FIG. 6, the user stores information (for example as to an exhibitor) that is probably not on the memory 104 but identified through interaction of the user and the user device 101; and the storing is to the mass storage 203 for later retrieval, for example off-line retrieval.

FIG. 6, ACT 6A: The user requests information forwarding. The information is of a type stored at the map DB 212. For example, the user has identified a product through browsing of the available products or from a visit to an exhibitor's station, and the user now wants to store the information (previously seen or unseen by the user) for later retrieval. The request is to the data management unit 210 and includes an identification of the information and the user's unique ID as an example of a user request ID.

FIG. 6, ACT 6B: In response to the user request, the data management unit 210 sends a search request to the map data management unit 206. The search request includes identification of the information (information on a location, type of product or particular product or particular exhibitor, for example) and the user's unique ID or some other search request ID.

FIG. 6, ACT 6C: The map data management unit 206, in response to the search request, searches its map DB (data base) 212 that cross-references locations, users, exhibitors, fixed facilities such as restrooms, information types and products. When a match is found, the search result, is sent to the data management unit 210 along with a return of the search request ID.

FIG. 6, ACT 6D: The data management unit 210, in response to relevant search result received, sends a confirmation of information forwarding including a request ID, for example the unique user ID, to the mass storage 203, where the information is to be stored.

FIG. 6, ACT 6E: In response to the confirmation of information forwarding, the storage 203 returns an allowance for forwarding indicating that the information is correctly identified and storage is available.

FIG. 6, ACT 6F: In response to the allowance for forwarding, the data management unit 210 forwards the information, along with an ID that is or leads to the unique user ID, to the mass storage 203, where the information is stored.

FIG. 6, ACT 6G: In response to the satisfactory reception and storing of the information, the mass storage 203 sends an announcement of completion of storage to the data management unit 210, which announcement includes an identification of the user, for example the user ID.

FIG. 6, ACT 6H: In response to the reception of the announcement of completion, the data management unit 210 sends an announcement of completion to the user terminal 101.

FIG. 6, ACT 61: After or prior to ACT 6H, the data management unit 210 provides source of analysis information to the user behavior analyzing unit 208, for example the user ID, the information stored, a time stamp, a date stamp and the like behavior indicating information.

FIG. 6, ACT 6J: In response to the reception of the source of analysis information, the user behavior analyzing unit 208 sends an announcement of completion to the data management unit 210 to indicate that the procedure is completed satisfactorily.

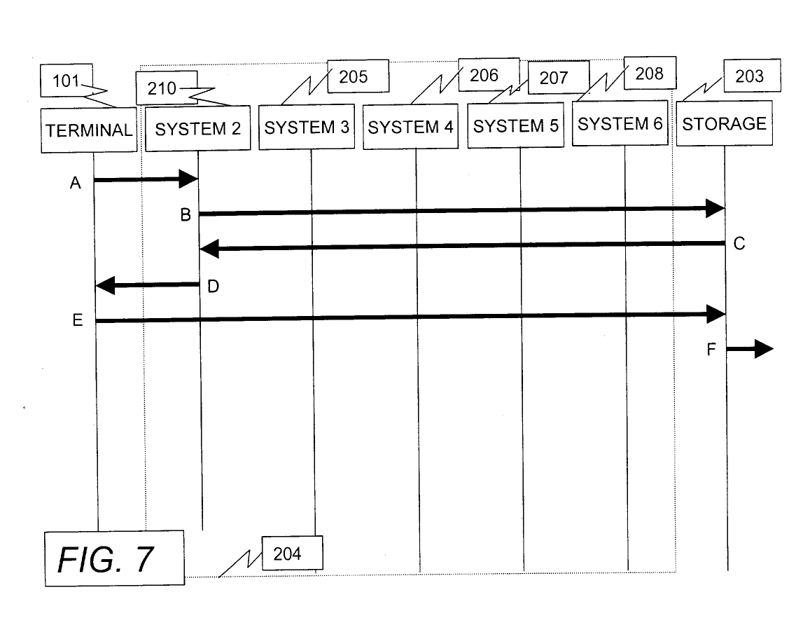

FIG. 7 disclosed an exchange of information between users, for example two visitors to the Convention Center.

FIG. 7, ACT 7A: A first user terminal sends a request for access to the storage account of another second user who desires information that the first user has already stored at the mass storage 203 for later retrieval. The access request is sent to the data management unit 210. The access request includes an identification of the first user and an identification of the second user. The identifications are preferably the unique user IDs obtained at the reception area of the Convention Center respectively by the first user and the second user when they entered the information location, that is, the Convention Center in the embodiment.

FIG. 7, ACT 7B: Upon receipt of the access request, the data management unit 210 provides any translation of user IDs sent by the user device 101 to corresponding user IDs that are understood by the mass storage 203, as necessary, and provides any translation of information IDs sent by the user device 101 to corresponding information IDs that are understood by the mass storage 203, as necessary. A connection request is then sent to the mass storage 203 along with the corresponding user IDs and information IDs. If the information IDs and user IDs provided by the user device 101 are the same as are understandable by the mass storage 203, it is not necessary that they all be sent to the mass storage at this time, although there are advantages to informing the mass storage of some connection ID, which could be the first user ID.

FIG. 7, ACT 7C: Upon receipt of the connection request, the mass storage preliminarily sets up a connection access or reserves connection capacity and then sends an allowance communication to the data management unit 210, with any necessary information to establish the connection.

FIG. 7, ACT 7D: Upon receipt of the allowance communication, the data management unit 210 sends the allowance communication reformation to the user terminal 10, after any necessary processing such as translation.

FIG. 7, ACT 7E: Upon receipt of the allowance communication, the user terminal 101 gains access directly with the mass storage 203. Then, the user terminal 101 sends any desired multimedia data, such as video captured with the integral video camera 109 of FIG. 1 or audio captured with the microphone 111, which multimedia data had been stored on the memory 104 of the user terminal 101. Also, the user terminal 101 may send information identities of multimedia data that have been stored on the mass storage 203 by the first user terminal 101- and which are now desired to be stored in the account of the second user at the mass storage 203. If the multimedia information is a already in the mass storage, for example as information provided by an exhibitor, it is only necessary to store a reference thereto in the second user's storage account at the mass storage 203. If the multimedia information is captured video and/or capture/d audio already in the mass storage under the account of the first user, it may be only necessary to store a reference thereto in the second user's storage account and set a do not delete flag in the account of the first user, each at the mass storage 203.

FIG. 7, ACT 7F: Upon receipt of the access communication from the first user device 101, the mass storage 203 establishes, changes and stores in, as needed, the account or archive of the second user, and if so commanded may forward the identified multimedia information over a LAN or WAN such as the Internet directly to an off-site private storage of the second user.

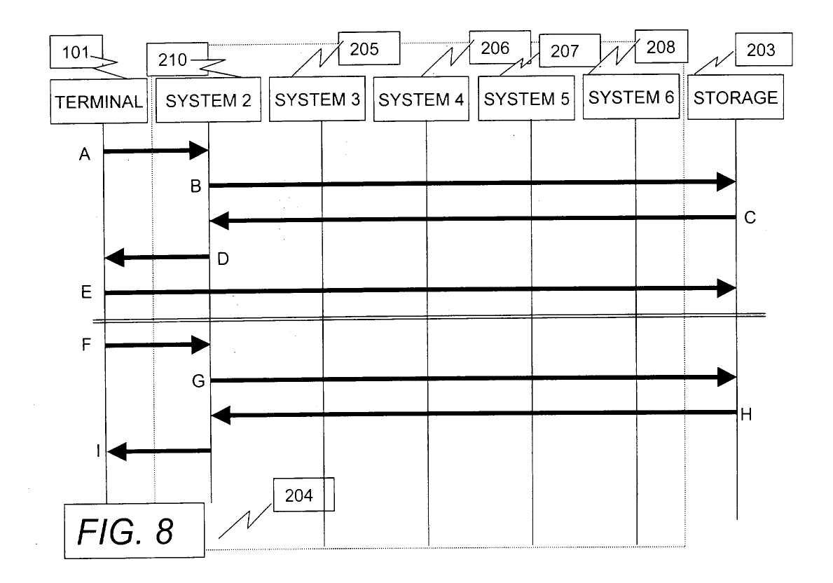

FIG. 8 illustrates a representative scenario of access to each user's information storage at the Convention Center and after leaving the Convention Center.

FIG. 8, ACT 8A: When at the Convention Center, at any time, the user, through command of their user terminal 101, may send an access request with user identification, for example the user ID, to the data management unit 210. The access request is for the purpose of permitting the user, through their terminal 101, to access their account at the mass storage 203, for example to browse the same for review, organization, refreshing their memory, etc. as to the multimedia information stored or referenced there.

FIG. 8, ACT 8B: Upon receipt of the access request, the data management unit 210 provides any translation of user ID sent by the user device 101 to a corresponding user ID that is understood by the mass storage 203, as necessary, and provides any translation of information IDs sent by the user device 101 to corresponding information IDs that are understood by the mass storage 203, as necessary. A connection request is then sent to the mass storage 203 along with the corresponding user ID and any information IDs. If the information IDs and user ID provided by the user device 101 are the same as are understandable by the mass storage 203, it is not necessary that they all be sent to the mass storage at this time, although there are advantages to informing the mass storage of some connection ID, which could be the user ID.

FIG. 8, ACT 8C: Upon receipt of the connection request, the mass storage preliminarily sets up a connection access or reserves connection capacity and then sends an allowance communication to the data management unit 210 with any necessary information to establish the connection.

FIG. 8, ACT 8D: Upon receipt of the allowance communication, the data management unit 210 sends the allowance communication to the user terminal 101, after any necessary processing such as translation or reformation.

FIG. 8, ACT 8E: Upon receipt of the allowance communication, the user terminal 101 gains access directly with the mass storage 203. Then, the user terminal 101 sends any desired multimedia data, such as video captured with the integral video camera 109 of FIG. 1 or audio captured with the microphone 111, which multimedia data had been stored on the memory 104 of the user terminal 101. If the multimedia information is a already in the mass storage, for example as information provided by an exhibitor, it is only necessary to store a reference thereto in the user's storage account at the mass storage 203. Also, the user terminal 101 may control browsing of the users storage account and multimedia data stored in or referenced in the account. The access is by two-way wireless communication.

FIG. 8, ACT 8F: An expiry request is sent by the user terminal 101 to the data management unit 210 when, for example: the user desires to close down their account temporarily, for example while attending a lecture or lunch; or upon leaving the Convention Center and turning in their user device 101; or under control of management at the reception area, for example, after leaving the Convention Center.

FIG. 8, ACT 8G: In response to receipt of the expiry request, the management unit 210 sends an off-line request to the mass storage 203 with the user ID.

FIG. 8, ACT 8H: Upon receipt of the off-line request, the mass storage closes the storage account or accounts corresponding to the received user ID with respect to on-line usage through the Convention Center LAN and to on-line usage by wireless communication. That is, the identified user account is placed in an off-line condition. Thereafter, the mass storage 203 sends an off-line announcement to the data management unit 210 that the identified account is now in the off-line condition.

FIG. 8, ACT 8: Upon receipt of the off-line announcement, the user device 101 notifies the user, for example through the display 102 and/or speaker 112 of FIG. 1, that the user device is now off-line, at least with respect to the mass storage. Accordingly, the user device 101 may disable one or more functions of the user device 101.

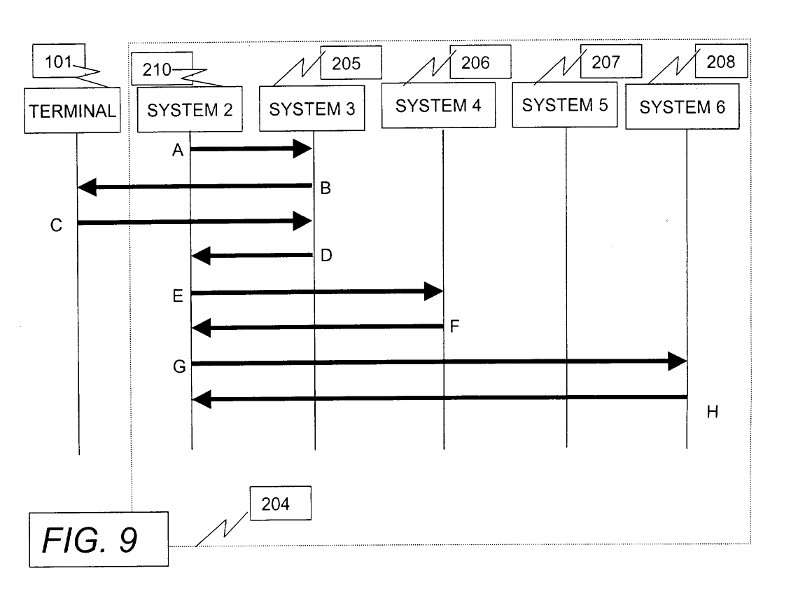

FIG. 9 illustrates a representative scenario for the gathering of time and location information relating to the behavior or actions of the user at the Convention Center.

FIG. 9, ACT 9A: Preferably at regular intervals, i.e. periodically, the data management unit 210 makes a request for location information as to the user by sending the request to the location analyzing unit 205.

FIG. 9, ACT 9B: In response to the request for location information, the location analyzing unit 205 sends a request to a specifically identified user terminal 101 for location information. The request is preferably through the location detector 202 over the Convention Center LAN and then wirelessly to the portable user device 101.

FIG. 9, ACT 9C: In response to the request for location information, the user's ID and location information (triangulation signals or GPS coordinates, e.g.) are provided wirelessly to the location detector 202 and from the location detector 202 by the Convention Center LAN to the location analyzing unit 205.

FIG. 9, ACT 9D: In turn, upon receipt of the user's ID and location information, the location analyzing unit 205 provides location information (the same as or derived from the location information of ACT C) for the specific user ID to the data management unit 210 by the Convention Center LAN. For example the location analyzing unit 205 maps the users GPS or triangulation location to grid coordinates of the Convention Center and provides the grid coordinates to the data management unit 210.

FIG. 9, ACT 9E: Upon receipt of the location information, the data management unit 210 may or may not reformat or translate the location information. The data management unit 210 then sends the location information and the user terminal ID or transmission ID, optionally with a time stamp, to the map data management unit 206.

FIG. 9, ACT 9F: In response to receipt of the location information from the data management unit 210, the map data management unit 206 overlays or maps the location information, e.g. grid coordinates to a real-time map having the information station locations and makes a determination that the identified user is within the immediate vicinity of or within a specific information station, and then sends the identity of the specific information station to the data management station 210 as the result of analyzing the location information. As another example, the location analyzing unit 205 maps the user location information to a map having the information station locations and fixed facilities such as the restrooms and food dispensing facilities and makes a determination that the identified user is within a specific restroom, and then sends the identity of the specific restroom to the data management station 210 as the result of analyzing the location information.

FIG. 9, ACT 9G: In response to receipt of the result of analyzing the location information, the data management unit 210 provides the result of analyzing the location information and corresponding user ID (and optionally a time stamp) to the user behavior analyzing unit 208.

FIG. 9, ACT 9H: In response to receipt of the result of analyzing the location information, the user behavior analyzing unit 208 analyzes the received result and the current time or substantially the current time (e.g. the time stamp of the data management unit 210 or the location analyzing unit 205 or the map data management unit 206, all of which would vary by the negligible processing and transmission delays) to determine or enhance a user profile for the identified user.

For example from a stored series of such information, the location information could be integrated over the time span that the user was at the specific location facility (exhibit station) to give an indication of the user's interest in the exhibit at the station, which is an example of a user profile. This could be combined, with weighting, with the users storing of multimedia information relating to that station to give a more meaningful user profile

As another example from a stored series of such information for different users, the location information could be integrated over the time span that each of the users were at the specific location facility (restroom) and then the integrations summed with respect to all users of the same restroom within a given time span or as a graph of usage vs. operating times, to give an indication of the usage peak times to plan facilities and to indicate the need for cleaning and servicing the specific restroom. The results could also be used in planning the need for new facilities or changing of the existing ones.

The result of such analyzing is sent, by the user behavior analyzing unit 208, to the data management unit 210, where it may be distributed to management, to an exhibitor visited, to a related exhibitor who may wish to then contact the user, to the convention organizers as an indication of follow-up or planning needed, etc.

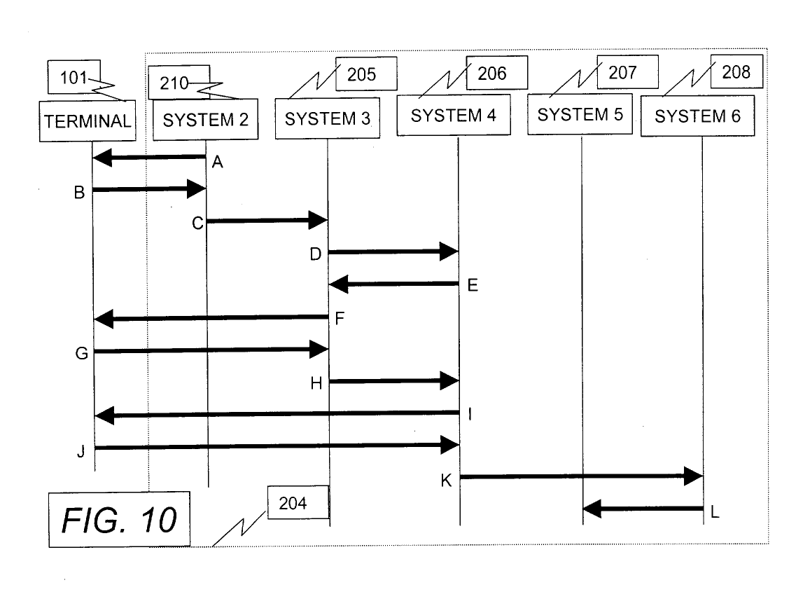

FIG. 10 illustrates a representative scenario for the gathering of category information relating to the behavior and actions of the user at the Convention Center.

FIG. 9, ACT 9A: Preferably at regular intervals, i.e. periodically, the data management unit 210 makes a request to the user terminal 101 to collect the location information as to the user. The request goes through the location detector 202 and is processed as described above.

FIG. 10, ACT 10B: Upon receipt of the request to collect the location information, the terminal 101 communicates to the data management unit 210 and the location is detected

FIG. 10, ACT 10C: Upon receipt of the location information from the user device or terminal 101, the data management unit 210, sends the location information and identification of the user (for example the user ID) to the location analyzing unit 205 for verification.

FIG. 10, ACT 10D: Upon receipt of the location information and identification of the user, the location analyzing unit 205 performs a verification, that is confirms the user identity and location within the Convention Center. The location analyzing unit 205 sends a request for corresponding exhibit information, for example in the grid coordinates of the Convention Center with the user ID, to the map data management unit.

FIG. 10, ACT 10E: Upon receipt of the request for exhibit information, the map data management unit 206 determines when the user terminal 101 is within or close to or even approaching (with GPS, the direction and speed of movement of the user is determined) an exhibit station. When the user terminal 101 meets certain criteria, for example is within an exhibit station, the map data management unit 206 provides the exhibit information corresponding to the determined exhibit station. The request for exhibit information provides an identification of the request, for example the user ID, and an identification of the exhibit station, or even a small portion of the exhibit when the exhibit station is extensive. The requested exhibit information is sent to the location analyzing unit 205

FIG. 10, ACT 10F: In response to receipt of the exhibit information and user ID, the location analyzing unit sends a query of acceptance of the exhibit information to the identified user terminal 101.

FIG. 10, ACT 10G: In response to receipt of the exhibit information and the query of acceptance, appropriate information is displayed, audio broadcast or the like communicated to the user who makes an acceptance or rejection choice. With user acceptance, the user terminal sends a request of reference to the location analyzing unit 205.

FIG. 10, ACT 10H: In response to receipt of the request of reference, the location analyzing unit 205 sends a request of reference to the map data management unit 206. The request identifies the user and the exhibit information directly or indirectly, for example.

FIG. 10, ACT 101: In response to receipt of the request of reference, the map data management unit 206 sends an approval to the user terminal 101. The approval identifies the user and the exhibit information directly or indirectly, for example

FIG. 10, ACT 10J: In response to receipt of the approval, the user terminal 101 sends a reference to the map data management unit 206. The reference identifies the user and the exhibit information directly or indirectly, for example.

FIG. 10, ACT 10K: In response to receipt of the reference, the map data management unit 206 provides the exhibit information referenced by the user to the user behavior analyzing unit 208.

FIG. 10, ACT 10L: In response to receipt of the exhibit information referenced by the user, the user behavior analyzing unit 208 uses the information to establish or update the behavior profile of the identified user. The behavior profile of the identified user is then sent to the exhibit information management unit 207 where it may be used to provide the most appropriate information to the user.

Each information location is a system of a plurality of related information stations.

The term information station refers to both a facilities at an information station as well as entities or providers involved in active presentation of information to a user at the information station. The information provider entity may be human, a computer system or multimedia system.

The term information location refers to any facility that dispenses information, for example a public or private space including museums, convention centers, retail displays, sporting arenas, open-air exhibits, cruise ships, information kiosks, resorts, ski resorts, amusement parks, hotels, hospitals, airports, educational or corporate campuses and the like that provide information to users.

At these information locations, there are the plurality of information stations, which may be kiosks, exhibitor booths, individual rented retail outlets, and the like. The user may be the general public, or those who have paid an entrance fee to attend such an event. At the stations, the user may be presented with audio/visual information, that is, mixed media, which would include fixed and animated exhibits, individuals, printed matter, audio material, and video material.

A user of the Fitzsimmons system appears to be able to access only a general library in the same manner as a person who never attended the event. That is, nothing specifically chosen by the user's previous visit and nothing stored by the user is correlated to the user upon a subsequent remote access to the library. In the present invention, the user, after leaving the convention center, can access remotely (e.g. over the Internet) specific information based upon preferences stored during a prior visit.

The information of the Fitzsimmons system appears to be pre-stored on the hard drive of the user device prior to the user obtaining the device. An IR transmitter in the Fitzsimmons system provides the user device with the user's location so that the user device knows what information to provide the user, through screen choices. Fitzsimmons requires a docking and downloading of information after the user has left the facility, and then the information is only usable with respect to the user profile and for tailoring information presentation through the portable device when the user returns.

In the present invention, the preferences are provided on a real time basis with real time communication between the user and the system profiler during the current visit to provide real time guidance of information provision based upon the changing profile.

The portable user device 101 transmits to the convention management system 204 preference indicating information, such as time spent at a specific exhibit station, number of digital stills or elapsed time of video captured at a specific exhibit station, audio interviews or noted elapsed time of audio information captured at a specific exhibit station, or information quantity downloaded at a station. The user behavior unit uses this information to create user profiles on a real time basis as the user is at and traversing the exhibit stations. The user profile is used on a real time basis to automatically provide suggestions of information based on the profile to the user during the visit, which suggestions may be as to other stations to visit, other services or products, lectures, for example. The profiles are also issued as results of analysis 214 for exhibitors, to aid in marketing or to management to design future facilities better or to manage the existing facilities in a better manner.

The user profiles are stored and indexed to the unique user ID to tailor the transmission of multimedia information to the user device throughout a subsequent visit at various appropriate times during the visit. Thereby the profile is linked to product or service information that the user may be interested in to receive at any time during the initial or subsequent visits or over a WAN. The profiling would include probabilistic measurement of the likelihood of the user being interested in specific information or information categories. The profile could be used by an exhibitor for follow-up contact of the user.

Various procedures have been described as event driven, and any of these may involve events such as elapsed periods, a user choice or demand, a user location or location and moving direction and/or speed, a user movement exceeding a predetermined reference value, or when exceeding a predetermined time since the last event driven procedure.

The present invention reduces the delays, long lines, miscommunications, missed opportunities and redundant business practices that have inconvenienced a user at such facilities. The present invention provides an improved locating of stations having relevant information, efficient obtaining of the information at a relevant station, quick and convenient transport and/or storage of the information between visits to different stations, and the convenient retrieval of the information after the event.

While the present invention has been described in connection with a number of embodiments, implementations, modifications and variations that have advantages specific to them, the present invention is not so limited but covers various obvious modifications and equivalent arrangements according to the broader aspects, which fall within the spirit and scope of the following claims.

What is claimed is:

1. A method for controlling the transfer of information between a portable user device and an information management system of a multimedia information presentation location having a plurality of information stations available for visit by the user, the method being computer controlled and performed by the information management system, the method comprising the steps of:
receiving, at the information location during the user's visit to the information presentation location, a wireless communication that comprises a user identification that is unique to a specific user together with computer readable data;
storing the computer readable data in a computer readable memory and indexed under a unique representation that is at least based upon the user identification; and
in response to receiving a user identification with a request for memory access, providing memory access to the computer readable data that is indexed corresponding to the user identification received with the request.

2. The method of claim 1, wherein the computer readable data represents audio information captured by the user.

3. The method of claim 2, further including:
conducting two-way wireless communications with each of the portable user devices;
based upon the wireless communications, determining a unique identification and location of each portable user device; and
profiling the user based upon the determined location at the time of said receiving and the length of running time of the audio information.

4. The method of claim 1, wherein the computer readable data represents video information captured by the user.

5. The method of claim 4, further including:
conducting two-way wireless communications with each of the portable user devices;
based upon the wireless communications, determining a unique identification and location of each portable user device; and
profiling the user based upon the determined location at the time of said receiving and the length of running time of the video information.

6. The method of claim 1, further including
in response to receiving two different user identifications with a request for information transfer, copying computer readable data that is indexed corresponding to one of the two different user identifications to storage indexed corresponding to the other of the two different user identifications.

7. The method of claim 1, further including:
conducting two-way wireless communications with each of the portable user devices;
based upon the wireless communications, determining a unique identification and location of each portable user device; and
profiling the user based upon the determined location at the time of said receiving and at least one additional characteristic of the computer readable data.

8. The method of claim 7, wherein said profiling is based upon the at least one additional characteristic being the length of time that the user device is at one information station.

9. The method of claim 1, wherein the computer readable data represents still image information captured by the user, and further comprising
conducting two-way wireless communications with each of the portable user devices;
based upon the wireless communications, determining a unique identification and location of each portable user device; and
profiling the user based upon the determined location at the time of said receiving and the number of still images captured by the user.

10. The method of claim 1, wherein said providing memory access is by wireless communication from the user device under control of the user during the user's visit to the information presentation location.

11. The method of claim 1, wherein said providing memory access is by remote communication over a WAN from the user after the user's visit to the information presentation location.

12. A method for controlling the transfer of information between a portable user device and an information management system of an information location having a plurality of information stations available for visit by the user, the method being computer controlled and performed by the information management system, comprising the steps of:
commonly storing information that is unique to each of a plurality of the information stations;
conducting two-way wireless communications with each of the portable user devices;
based upon the wireless communications, determining a unique identification and location of each portable user device;
based upon the determined location of a specific identified portable user device, selecting information of probable interest to the identified user from among the commonly stored information; and
wirelessly transmitting the selected information together with the user identification.

13. The method of claim 12, further including:
mapping the determined location of each user device to a map of the information location that includes each of the information stations and basing said selecting on said mapping.

14. The method of claim 13, wherein
the map further includes fixed support facilities and presentations; and
said transmitting including transmitting a display of the map to a user device showing the corresponding determined location.

15. The method of claim 13, wherein
the map further includes fixed support facilities; and
said transmitting including transmitting a display of the map to a user device showing the corresponding determined location.

16. The method of claim 12, wherein
said transmitting including providing a location of information stations having relevant information based upon both current behavior of the user and the determined location.

17. A method for controlling the transfer of information between a portable user device and an information management system of a multimedia information presentation location having a plurality of information stations available for visit by the user, the method being computer controlled and performed by the information management system, the method comprising the steps of:
conducting two-way wireless communications with each of the portable user devices;
based upon the wireless communications, determining a unique identification and location of each portable user device;
receiving, at the information location, a wireless communication that comprises a user identification that is unique to a specific user together with computer readable data relating to information of interest to the user; and
and in response to said receiving, profiling the user based upon the determined location at the time of said receiving and at least one additional characteristic of the computer readable data.

18. The method of claim 17, wherein
the computer readable data represents audio information captured by the user; and
said profiling is based upon the at least one additional characteristic being the length of running time of the audio information.

19. The method of claim 17, wherein
the computer readable data represents video information captured by the user; and
said profiling is based upon the at least one additional characteristic being the length of running time of the video information.

20. The method of claim 17, wherein
said profiling is based upon the at least one additional characteristic being an information choice presented to the user device as a wireless download option and which choice was not downloaded.

21. The method of claim 17, wherein
said profiling is based upon the at least one additional characteristic being the length of time that the user device is at one information station.

22. A method for controlling the transfer of information between a portable user device and an information management system of a multimedia information presentation location having a plurality of information stations available for visit by the user, the method being computer controlled and performed by the information management system, the method comprising the steps of:
receiving, at the information location, a wireless communication that comprises a user identification that is unique to a specific user together with computer readable data representing information of interest to the user;
storing the computer readable data in a computer readable memory and indexed under a unique representation that is at least based upon the user identification; and
in response to receiving two different user identifications with a single request for information transfer, copying computer readable data that is indexed corresponding to one of the two different user identifications to storage indexed corresponding to the other of the two different user identifications.

23. The method of claim 22, wherein said receiving two different user identifications with a single request is a wireless reception from within the information location.

24. A computer readable storage medium, comprising:
a computer readable program for directing a plurality of uniquely identified computer containing mobile user devices and a computer controlled management system in performance of the process steps of claim 1.

25. A computer readable storage medium, comprising:
a computer readable program for directing a plurality of uniquely identified computer containing mobile user devices and a computer controlled management system in performance of the process steps of claim 6.

26. A computer readable storage medium, comprising:
a computer readable program for directing a plurality of uniquely identified computer containing mobile user devices and a computer controlled management system in performance of the process steps of claim 12.

27. A computer readable storage medium, comprising:
a computer readable program for directing a plurality of uniquely identified computer containing mobile user devices and a computer controlled management system in performance of the process steps of claim 13.

28. A computer readable storage medium, comprising:
a computer readable program for directing a plurality of uniquely identified computer containing mobile user devices and a computer controlled management system in performance of the process steps of claim 20.

29. A computer readable storage medium, comprising:
a computer readable program for directing a plurality of uniquely identified computer containing mobile user devices and a computer controlled management system in performance of the process steps of claim 21.

30. A computer readable storage medium, comprising:
a computer readable program for directing a plurality of uniquely identified computer containing mobile user devices and a computer controlled management system in performance of the process steps of claim 22.
